(19) United States
(12) Patent Application Publication
(10) Pub. No.: US 2008/0156961 A1
(43) Pub. Date: Jul. 3, 2008

(54) Vibration isolation mount for a motor assembly

(76) Inventor: David Finkenbinder, Ravenna, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/647,953

(22) Filed: Dec. 29, 2006

(51) Int. Cl. H02K 5/24

(52) U.S. Cl. 248/610

(57) ABSTRACT

A vibration isolation mount for mounting an electric motor to a device support structure includes a body having a motor-engaging end and a mount end and a central axis. A screw fastener extends from the motor-engaging end and is coaxial with the central axis of the body. A threaded bushing extends into the body at the mount end thereof. In a method of use, the vibration isolation mount is secured to a motor support structure of the electric motor by driving the screw fastener into the motor support structure. The electric motor is mounted to a device support structure by driving a fastener through the device support structure to mate with the threaded bushing of the vibration isolation mount.

### TECHNICAL FIELD

The present invention generally relates to electric motors or generators. More particularly this invention relates to a vibration isolation mount for a motor-fan unit, and a method of installing the vibration isolation mount.

### BACKGROUND ART

Electric motors and generators are well known in the art and have been put to use in a variety of applications. One application is the handling of air. In these circumstances an electric motor is coupled with a fan to generate an air flow or vacuum as necessary. Often, the fan is used to provide cooling air to the motor. In these instances, a fan mounted on a shaft driven by the motor draws air into a fan shroud to compress or pressurize the air. The pressurized air is released into the motor housing via one or more ports which direct the air across the motor windings to draw heat into the flow and exhaust it from the motor housing. Alternatively, the shroud may have exhaust ports so that the air-flow bypasses the motor windings.

These electric motors must be securely mounted in the devices in which they are used. Because they have fast moving parts, the motors are preferably mounted through what will be termed herein “vibration isolation mounts.” A vibration isolation mount serves to dampen vibrations between the motor and the supporting structure to which the motor is mounted.

A prior art vibration isolation mount is shown in FIG. 1 and designated by the numeral 10. It includes a rubber body 12 having a through bore 14 running from a mount end 16 to a motor-engaging end 18 thereof. This rubber body 12 is used to mount a motor to a desired device by sandwiching the rubber body between a motor support structure 20 of the electric motor and a device support structure 22 provided by the desired device. More particularly, a threaded bushing 24 is provided in the motor support structure 20 to receive a screw fastener 26, and this screw fastener 26 is inserted through the device support structure 22 and the through bore 14 to engage the threads of the threaded bushing 24 and pull the assembly securely together, thus mounting the electric motor to the support assembly with the vibration dampening rubber body 12 between the motor and the device support structure 22.

The motor support structures 20 are often plastic, so, in order to create a secure fit, the threaded bushing 24 is often made of brass and is secured to the plastic support structure 20. This ensures that the receipt structure of the electric motor is not easily compromised by the threading of the screw fastener 26 therein, as it could be if the screw fastener were to be secured directly to a plastic motor support structure 20. The metal structure of the threaded bushing 24 helps ensure that the threads of the screw fastener 26 or threaded bushing 24 are not stripped by an over aggressive threading of the screw fastener 26 to the threaded bore 24. The use of a metal threaded bushing 24 increases the expense of the end assembly. Additionally, this prior art vibration isolation mount assembly has a multitude of parts that must be aligned to be finally assembled, and this increases the amount of labor that must go into creating an electric motor with mounting capabilities as just described. The multiple parts and assembly method required for this vibration isolation mount assembly of the prior art unduly complicates the mounting process.

Thus, there exists a need in the art for an improved vibration isolation mount device and method, decreasing assembly parts and simplifying the assembly process.

### SUMMARY OF THE INVENTION

In light of the need in the art, this invention provides a vibration isolation mount for an electric motor. The vibration isolation mount includes a body having a motor-engaging end and a mount end and a central axis. A screw fastener extends from the motor-engaging end and is coaxial with the central axis of the body. A threaded bushing extends into the body at the mount end thereof.

The vibration isolation mount is preferably constructed by molding the body to the screw fastener and the threaded bushing. That is, the screw fastener and threaded bushing are preferably provided in a mold for the vibration isolation mount, and rubber or other polymeric material is then injected into the mold and allowed to set, thus securing the screw fastener and threaded bushing to the body formed. By positioning the screw fastener coaxial with the central axis of the body, the screw fastener can be rotationally driven into a support structure by driving the body about its central axis.

This invention also provides a method for mounting an electric motor to a device having a device support structure. The method employs a vibration isolation mount including a body having a motor-engaging end and a mount end and a central axis; a screw fastener extending from the motor-engaging end and coaxial with the central axis; and a threaded bushing extending into the body at the mount end thereof. The vibration isolation mount is secured to a motor support structure of the electric motor by diving the screw fastener into the motor support structure. The threaded bushing of the vibration isolation mount is then aligned with the device support structure, and a mounting screw is driven through the device support structure to mate with the threaded bushing, thus mounting the electric motor to the device support structure with the body serving to dampen vibrations between the device and the electric motor.

### BRIEF DESCRIPTION OF THE DRAWINGS

For a complete understanding of the objects, techniques and structure of the invention, reference should be made to the following detailed description and accompanying drawings, wherein:

FIG. 1 is an assembly diagram of a prior art vibration isolation mount assembly;

FIG. 2 is a side cross-sectional view of a vibration isolation mount in accordance with this invention;

FIG. 3 is a top plan view of the vibration isolation mount in accordance with this invention;

FIG. 4 shows vibration isolation mounts of this invention secured to an electric motor unit; and

FIG. 5 shows the mounting of the electric motor of FIG. 4 to a support structure provided in a device to which the electric motor is to be mounted.

### DETAILED DESCRIPTION OF THE INVENTION

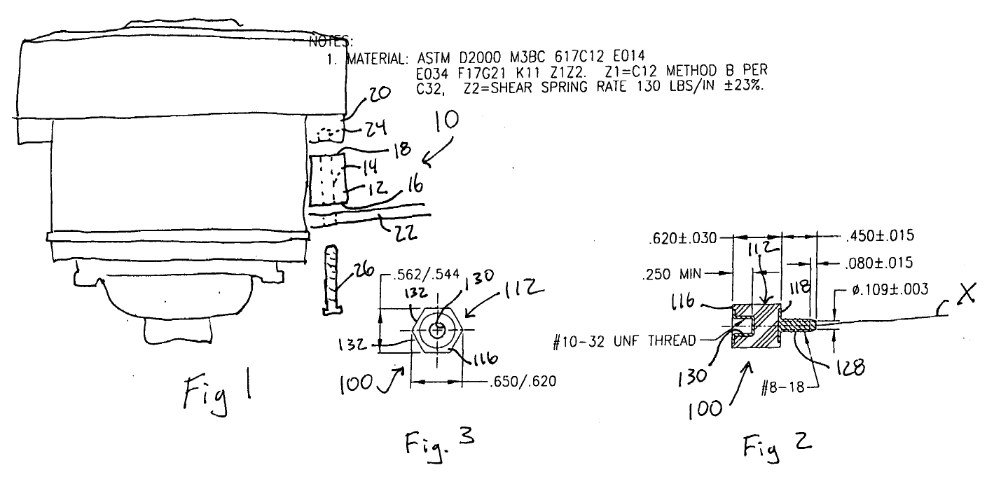

The vibration isolation mount of this invention is shown and designated by the numeral 110 in FIG. 2. The vibration isolation mount 100 includes a body 112 having a mount end 116 and a motor-engaging end 118. In one embodiment, the body 112 is made from a polymeric material such as rubber, although other similar materials could be employed. Suitable materials can be broadly characterize by being vibration dampening materials, i.e., materials capable of dampening vibration forces. There is no through bore, as in the prior art rubber body portion (rubber body 12) of the prior art vibration isolation mount assemblies. Rather, a screw fastener 128 is secured to the body 112 at motor-engaging end 118, and a threaded bushing 130 is secured to and extends into the body 112 at mount end 116. Preferably, the screw fastener 128 is coaxial with the central axis X of the body 112 so that the screw fastener 128 can be rotationally driven into a suitable structure through rotation of the body 112. The threaded bushing 130 is also preferably coaxial with the axis X, though it is less material that it be so positioned.

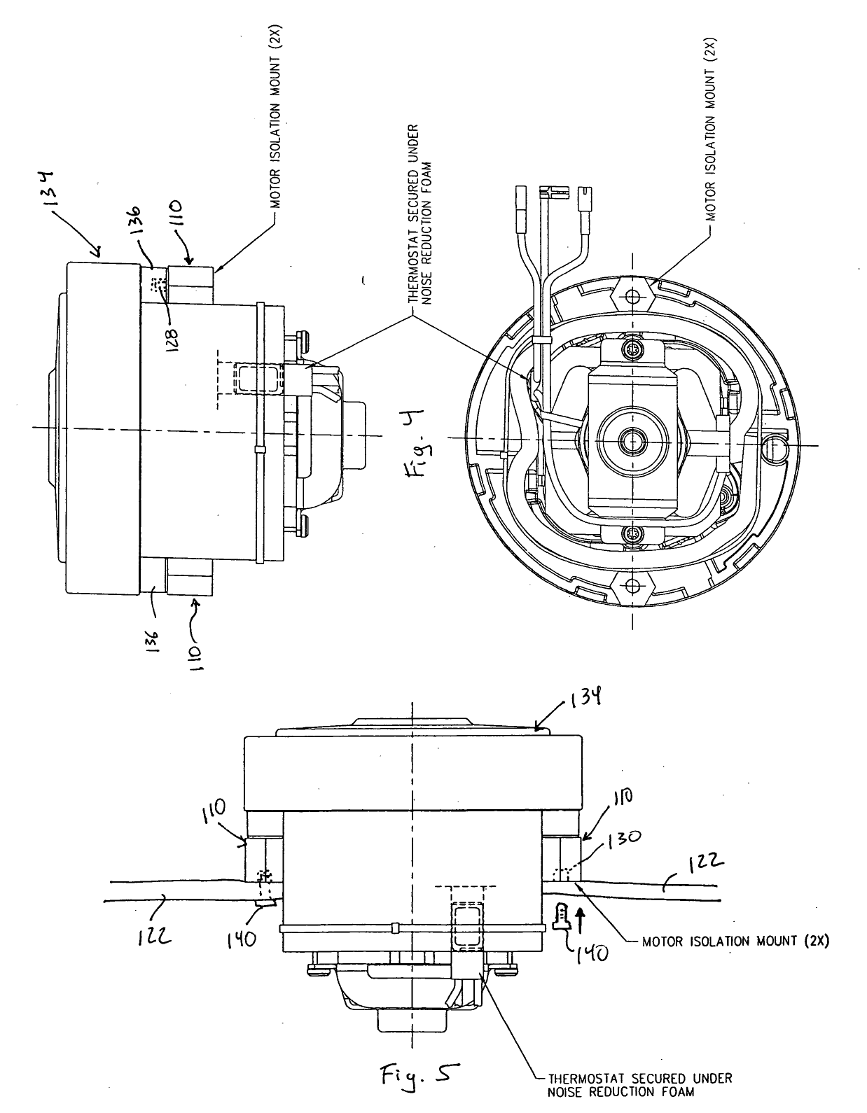

Although this invention is not limited to or by such a structure, the body 112 is preferably hexagonal in cross section, having a plurality of faces 132 coaxial with axis X, as shown in FIG. 3, or has some other cross sectional structure to interact with common drill bits (e.g., nut driver bits) or wrenches. With the hexagonal cross section, as shown, the vibration isolation mount 110 can be driven into an appropriate structure through the engagement of a drill bits or wrench with body 112.

Material to form the body 112 is injected into a mold holding the screw fastener 128 and threaded bushing 130 in the relative positions shown in the finished product of vibration isolation mount 110. The rubber or other polymeric material sets, holding the entirety together as a final unitary product. Alternatively, or with the use of different rubbers or elastomers, adhesive could be used to secure these elements together.

It has been found that the general structure for a vibration isolation mount according to mount 110 can be used to decrease the costs and simplify the labor involved in mounting a vibration isolation mount to a motor housing and mounting the motor housing to a support structure. This is particularly true for plastic motor housings.

Referring now to FIG. 4, an electric motor 134 is shown with a plastic motor support structure 136. This support structure will be recognized as a fan end bracket, and it will be appreciated that it is more generically referred to as a motor support structure 136 herein inasmuch as the chosen support structure for mounting the electric motor does not have to be located as shown. The vibration isolation mount 110 is secured to the motor support structure 136 by means of the screw fastener 128 being driven into the structural material forming the motor support structure 136. As is known, the screw fastener 128 can be chosen to be of the type that can be driven directly into a plastic material, or, optionally, a relatively small guide bore can be provided in the motor support structure 136 to aid in driving the screw fastener 128 into the motor support structure 136.

It will be appreciated that the screw fastener 128 creates threads within motor support structure 136 as it is driven therein, and excessive driving of the screw fastener 128 into motor support structure 136 could lead to the stripping of the threads created. If this were to occur, the screw fastener 128 would not be able to secure the vibration isolation mount 110 to the motor support structure 136. Thus, in accordance with one method for driving vibration isolation mount 110 into motor support structure 136, a drill is employed with an appropriate drill torque setting to ensure that the screw fastener 128 is not driven to strip threads. In accordance with another embodiment, the cross section of the body 112 is chosen to be slightly smaller than the cross section of a drill socket that is to be used to drive the screw fastener into the motor support structure 136. Because the body 112 is somewhat flexible, by sizing it slightly smaller than the drill socket cross section, an automatic slip is created between the drill socket and the body when the torque on the body is great enough. Through normal experimentation and/or standard calculations based upon durometer, elongation, tensile strength and the like, an appropriate sizing can be obtained for this purpose.

The assembled structure shown in FIG. 4 can then be mounted to a device support structure 122 by means of the threaded bushing 130 provided by the vibration isolation mount 110. This is accomplished simply by aligning the threaded bushing 130 with a device support structure 122 and driving a mounting screw 140 through the device support structure 122 to mate with the threads of threaded bushing 130, as shown in FIG. 5.

This invention advances the art by simplifying the mounting of a motor unit to a desired device. The motor unit and the vibration isolation mount in accordance with this invention can be assembled and shipped or stored as a unit until it is necessary to mount the unit to a device support structure, at which time a simple fastener can be driven through the device support structure to engage the threaded bushing of the vibration isolation mount. To ensure that plastic parts are not stripped when driving the vibration isolation mount into a motor support structure, a clutch mechanism or the above-mentioned sizing or both can be practiced.

From the forgoing, it should be apparent that the vibration isolation mount and method disclosed herein substantially improves the art. While only preferred embodiments have been disclosed herein in accordance with the patent statutes, modifications of this invention will be apparent to those of ordinary skill in the art, and the invention is not to be limited to or by any specific disclosure. The claims serve to define the invention.

1. A vibration isolation mount for an electric motor comprising:
a body having a motor-engaging end and a mount end and a central axis, said body being formed of a vibration dampening material;
a screw fastener extending from said motor-engaging end and coaxial with said central axis; and
a threaded bushing extending into said body at said mount end thereof.

2. The vibration isolation mount of claim 1, wherein said threaded bushing is coaxial with said central axis.

3. The vibration isolation mount of claim 1, wherein said screw fastener is metal and is designed to be driven into plastic.

4. The vibration isolation mount of claim 3, wherein said threaded bushing is metal.

5. The vibration isolation mount of claim 4, wherein said body is molded to said threaded bushing and said screw fastener.

6. A method for mounting an electric motor to a device having a device support structure, the method comprising the steps of:
(a) securing a vibration isolation mount to a motor support structure, the vibration isolation mount comprising:
a body having a motor-engaging end and a mount end and a central axis,
a screw fastener extending from the motor-engaging end and coaxial with the central axis, and
a threaded bushing extending into the body at the mount end thereof,
wherein the vibration isolation mount is secured to the motor support structure by driving the screw fastener into the motor support structure;
(b) aligning the threaded bushing with the device support structure; and
(c) driving a mounting screw through the device support structure to mate with the threaded bushing, thus mounting the electric motor to the device support structure with the body serving to dampen vibrations between the device and the electric motor.

7. The method of claim 6, wherein said body is formed of a vibration dampening material.
